(19) United States
(12) Patent Application Publication
(10) Pub. No.: US 2011/0292917 A1
(43) Pub. Date: Dec. 1, 2011

(54) SYSTEM AND METHOD FOR TIMING ADJUSTMENT TO PROTECT CQI

(75) Inventors: Zhifei Fan, San Diego, CA (US); Hao Xu, San Diego, CA (US); Yongbin Wei, San Diego, CA (US); Onur Senel, San Diego, CA (US); Zhengwei Liu, San Diego, CA (US); Vikas Jain, San Diego, CA (US)

(73) Assignee: QUALCOMM INCORPORATED, San Diego, CA (US)

(21) Appl. No.: 13/116,314

(22) Filed: May 26, 2011

Related U.S. Application Data
(60) Provisional application No. 61/349,115, filed on May 27, 2010.

(51) Int. Cl. H04W 72/12

(52) U.S. Cl. 370/336; 370/329

(57) ABSTRACT

Certain aspects of the present disclosure propose methods for protecting channel quality indicator (CQI) modulation symbols in a subframe (e.g., a localized frequency division multiplexing (LFDM) subframe). For some aspects, a timing adjustment method may be utilized to adjust time of a UE with respect to an eNodeB. The timing adjustment method may introduce a positive time offset to be used for reducing time mismatch between the UE and the eNodeB. In another aspect, a buffer may be used at the eNodeB to store symbols received by the eNodeB before removing the cyclic prefix information from the subframe. The eNodeB may use the stored symbols and an artificial time delay to ensure that the CQI information is protected. For some aspects, the CQI modulation symbols may not be located at the beginning of an LFDM symbol.

### CLAIM OF PRIORITY UNDER 35 U.S.C. §119

The present Application for Patent claims priority to U.S. Provisional Application No. 61/349,115, entitled, “Timing Adjustment to Protect CQI on PUSCH in LTE System,” filed May 27, 2010, and assigned to the assignee hereof and hereby expressly incorporated by reference herein.

### TECHNICAL FIELD

Certain aspects of the present disclosure generally relate to wireless communications and, more particularly, to a method for communication of feedback information in advanced wireless communication systems.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

### SUMMARY

Certain aspects provide a method for scheduling channel information feedback in a wireless system. The method generally includes receiving, at a UE, a time adjustment command for advancing or retarding a start time of an uplink transmission, adjusting the start time of the uplink transmission based on the time adjustment command and a positive time bias, and sending an uplink transmission including a channel quality indicator (CQI) at the adjusted start time.

Certain aspects provide an apparatus for scheduling channel information feedback in a wireless system. The apparatus generally includes means for receiving, at a UE, a time adjustment command for advancing or retarding a start time of an uplink transmission, means for adjusting the start time of the uplink transmission based on the time adjustment command and a positive time bias, and means for sending an uplink transmission including a channel quality indicator (CQI) at the adjusted start time.

Certain aspects provide an apparatus for scheduling channel information feedback in a wireless system. The apparatus generally includes at least one processor and a memory coupled to the at least one processor, the at least one processor being configured to receive, at a UE, a time adjustment command for advancing or retarding a start time of an uplink transmission, adjust the start time of the uplink transmission based on the time adjustment command and a positive time bias, and send an uplink transmission including a channel quality indicator (CQI) at the adjusted start time.

Certain aspects provide a computer-program product for scheduling channel information feedback in a wireless system. The computer-program product generally includes a computer-readable medium comprising code for receiving, at a UE, a time adjustment command for advancing or retarding a start time of an uplink transmission, adjusting the start time of the uplink transmission based on the time adjustment command and a positive time bias, and sending an uplink transmission including a channel quality indicator (CQI) at the adjusted start time.

Certain aspects provide a method for scheduling channel information feedback in a wireless system. The method generally includes determining, based on timing of a received uplink transmission, whether or not a UE needs timing adjustment for a subsequent uplink transmission, transmitting a time adjustment command instructing a UE to adjust timing of the subsequent uplink transmissions based at least on a positive time bias, receiving the subsequent uplink transmission, and processing the received uplink transmissions to extract channel quality indicator (CQI).

Certain aspects provide an apparatus for scheduling channel information feedback in a wireless system. The apparatus generally includes means for determining, based on timing of a received uplink transmission, whether or not a UE needs timing adjustment for a subsequent uplink transmission, means for transmitting a time adjustment command instructing a UE to adjust timing of the subsequent uplink transmissions based at least on a positive time bias, means for receiving the subsequent uplink transmission, and means for processing the received uplink transmissions to extract channel quality indicator (CQI).

Certain aspects provide an apparatus for scheduling channel information feedback in a wireless system. The apparatus generally includes at least one processor and a memory coupled to the at least one processor, the at least one processor being configured to determine, based on timing of a received uplink transmission, whether or not a UE needs timing adjustment for a subsequent uplink transmission, transmit a time adjustment command instructing a UE to adjust timing of the subsequent uplink transmissions based at least on a positive time bias, receive the subsequent uplink transmission, and process the received uplink transmissions to extract channel quality indicator (CQI).

Certain aspects provide a computer-program product for scheduling channel information feedback in a wireless system. The computer-program product generally includes a computer-readable medium comprising code for determining, based on timing of a received uplink transmission, whether or not a UE needs timing adjustment for a subsequent uplink transmission, transmitting a time adjustment command instructing a UE to adjust timing of the subsequent uplink transmissions based at least on a positive time bias, receiving the subsequent uplink transmission, and processing the received uplink transmissions to extract channel quality indicator (CQI).

Certain aspects provide a method for scheduling channel information feedback in a wireless system. The method generally includes receiving, at an eNodeB, an uplink transmission comprising channel feedback information, applying a timing delay to the received uplink transmission such that the uplink transmission and an additional signal amount are buffered, and processing the uplink transmission to extract channel feedback information.

Certain aspects provide an apparatus for scheduling channel information feedback in a wireless system. The apparatus generally includes means for receiving, at an eNodeB, an uplink transmission comprising channel feedback information, means for applying a timing delay to the received uplink transmission such that the uplink transmission and an additional signal amount are buffered, and means for processing the uplink transmission to extract channel feedback information.

Certain aspects provide an apparatus for scheduling channel information feedback in a wireless system. The apparatus generally includes at least one processor and a memory coupled to the at least one processor, the at least one processor being configured to receive, at an eNodeB, an uplink transmission comprising channel feedback information, apply a timing delay to the received uplink transmission such that the uplink transmission and an additional signal amount are buffered, and process the uplink transmission to extract channel feedback information.

Certain aspects provide a computer-program product for scheduling channel information feedback in a wireless system. The computer-program product generally includes a computer-readable medium comprising code for receiving, at an eNodeB, an uplink transmission comprising channel feedback information, receiving, at an eNodeB, an uplink transmission comprising channel feedback information, and processing the uplink transmission to extract channel feedback information.

Certain aspects provide a method for transmitting channel information feedback in a wireless system. The method generally includes generating, at a UE, an uplink transmission comprising channel information feedback, wherein the channel information feedback is not positioned at a beginning of a localized frequency division multiplexing (LFDM) frame, and transmitting the uplink transmission to an eNodeB.

Certain aspects provide an apparatus for transmitting channel information feedback in a wireless system. The apparatus generally includes means for generating, at a UE, an uplink transmission comprising channel information feedback, wherein the channel information feedback is not positioned at a beginning of a localized frequency division multiplexing (LFDM) frame, and means for transmitting the uplink transmission to an eNodeB.

Certain aspects provide an apparatus for transmitting channel information feedback in a wireless system. The apparatus generally includes at least one processor and a memory coupled to the at least one processor, the at least one processor being configured to generate, at a UE, an uplink transmission comprising channel information feedback, wherein the channel information feedback is not positioned at a beginning of a localized frequency division multiplexing (LFDM) frame, and transmit the uplink transmission to an eNodeB.

Certain aspects provide a computer-program product for transmitting channel information feedback in a wireless system. The computer-program product generally includes a computer-readable medium comprising code for generating, at a UE, an uplink transmission comprising channel information feedback, wherein the channel information feedback is not positioned at a beginning of a localized frequency division multiplexing (LFDM) frame, and transmitting the uplink transmission to an eNodeB.

Certain aspects provide a method for processing channel information feedback in a wireless system. The method generally includes receiving, from a UE, an uplink transmission comprising channel information feedback, wherein the channel information feedback is not positioned at a beginning of a localized frequency division multiplexing (LFDM) frame, and extracting the channel information feedback from the uplink transmission.

Certain aspects provide an apparatus for processing channel information feedback in a wireless system. The apparatus generally includes means for receiving, from a UE, an uplink transmission comprising channel information feedback, wherein the channel information feedback is not positioned at a beginning of a localized frequency division multiplexing (LFDM) frame, and means for extracting the channel information feedback from the uplink transmission.

Certain aspects provide an apparatus for processing channel information feedback in a wireless system. The apparatus generally includes at least one processor and a memory coupled to the at least one processor, the at least one processor being configured to receive, from a UE, an uplink transmission comprising channel information feedback, wherein the channel information feedback is not positioned at a beginning of a localized frequency division multiplexing (LFDM) frame, and extract the channel information feedback from the uplink transmission.

Certain aspects provide a computer-program product for processing channel information feedback in a wireless system. The computer-program product generally includes a computer-readable medium comprising code for receiving, from a UE, an uplink transmission comprising channel information feedback, wherein the channel information feedback is not positioned at a beginning of a localized frequency division multiplexing (LFDM) frame, and extracting the channel information feedback from the uplink transmission.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example multiple access wireless communication system in accordance with certain aspects of the present disclosure.

FIG. 2 illustrates a block diagram of an access point and a user equipment in accordance with certain aspects of the present disclosure.

FIG. 3 is a block diagram conceptually illustrating an example of a downlink frame structure in a telecommunications system.

FIG. 4 is a block diagram conceptually illustrating an example of an uplink frame structure in a telecommunications system utilizing localized frequency division multiplexing (LDFM).

FIG. 5 illustrates a block diagram conceptually illustrating an operation of an eNodeB with a user equipment, in accordance with certain aspects of the present disclosure.

FIG. 6 illustrates example operations that may be performed by a user equipment, in accordance with certain aspects of the present disclosure.

FIG. 7 illustrates example operations that may be performed by an eNodeB in accordance with certain aspects of the present disclosure.

FIG. 8 illustrates example operations that may be performed by an eNodeB in accordance with certain aspects of the present disclosure.

FIG. 9 illustrates example operations that may be performed by a user equipment in accordance with certain aspects of the present disclosure.

FIG. 10 illustrates example operations that may be performed by an eNodeB in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects the node is a wireless node. Such wireless node may provide, for example, connectivity for or to a network (e.g., a wide area network such as the Internet or a cellular network) via a wired or wireless communication link.

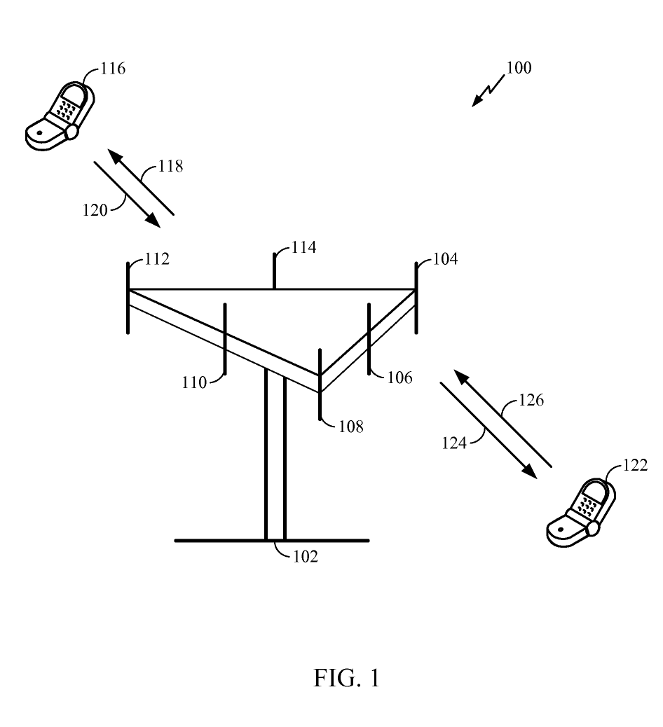

Referring to FIG. 1, a multiple access wireless communication system according to one aspect is illustrated. An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In one aspect of the present disclosure each antenna group may be designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

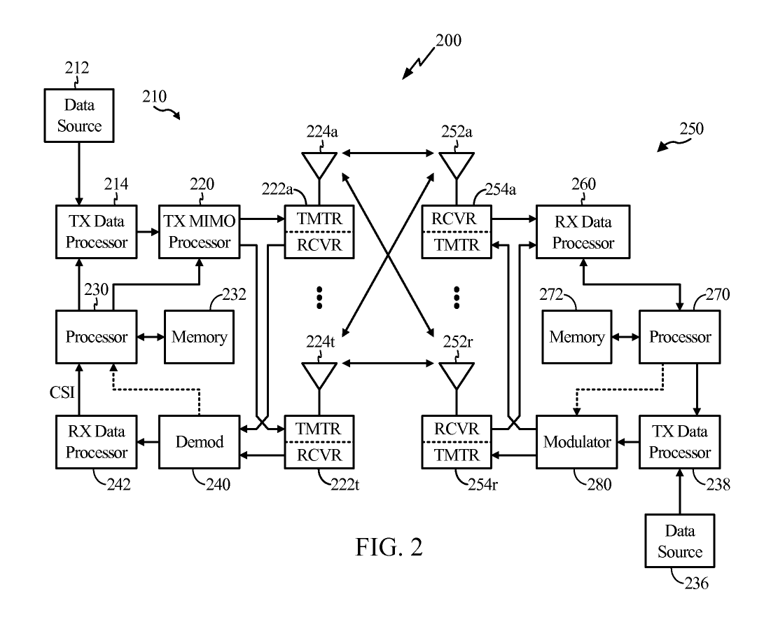

FIG. 2 illustrates a block diagram of an aspect of a transmitter system 210 (also known as the access point) and a receiver system 250 (also known as the access terminal) in a multiple-input multiple-output (MIMO) system 200. At the transmitter system 210, traffic data for a number of data streams is provided from a data source 212 to a transmit (TX) data processor 214.

In one aspect of the present disclosure, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., binary phase shift keying (BPSK), Quadrature phase shift keying (QSPK), M-PSK, or M-QAM) selected for that data stream to provide modulation symbols. The data rate, coding, and modulation for each data stream may be determined by instructions stored in memory 232 and performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion using instructions stored in memory 272. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

In one aspect of the present disclosure, logical wireless communication channels may be classified into control channels and traffic channels. Logical control channels may comprise a Broadcast Control Channel (BCCH) which is a downlink (DL) channel for broadcasting system control information. A Paging Control Channel (PCCH) is a DL logical control channel that transfers paging information. A Multicast Control Channel (MCCH) is a point-to-multipoint DL logical control channel used for transmitting Multimedia Broadcast and Multicast Service (MBMS) scheduling and control information for one or several Multicast Traffic Channels (MTCHs). Generally, after establishing Radio Resource Control (RRC) connection, the MCCH may be only used by user terminals that receive MBMS. A Dedicated Control Channel (DCCH) is a point-to-point bi-directional logical control channel that transmits dedicated control information and it is used by user terminals having an RRC connection. Logical traffic channels may comprise a Dedicated Traffic Channel (DTCH) which is a point-to-point bi-directional channel dedicated to one user terminal for transferring user information. Furthermore, logical traffic channels may comprise a Multicast Traffic Channel (MTCH), which is a point-to-multipoint DL channel for transmitting traffic data.

Transport channels may be classified into DL and UL channels. DL transport channels may comprise a Broadcast Channel (BCH), a Downlink Shared Data Channel (DL-SDCH) and a Paging Channel (PCH). The PCH may be utilized for supporting power saving at the user terminal (i.e., Discontinuous Reception (DRX) cycle may be indicated to the user terminal by the network), broadcasted over entire cell and mapped to physical layer (PHY) resources which can be used for other control/traffic channels. The UL transport channels may comprise a Random Access Channel (RACH), a Request Channel (REQCH), an Uplink Shared Data Channel (UL-SDCH) and a plurality of PHY channels.

The PHY channels may comprise a set of DL channels and UL channels. The DL PHY channels may comprise: Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), and Load Indicator Channel (LICH). The UL PHY Channels may comprise: Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH).

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal fast Fourier transform (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (e.g., 6 resource blocks), and there may be 1, 2, 4, 8 or 16 subbands for system bandwidth of 1.25, 2.5, 5, 10 or 20 MHz, respectively.

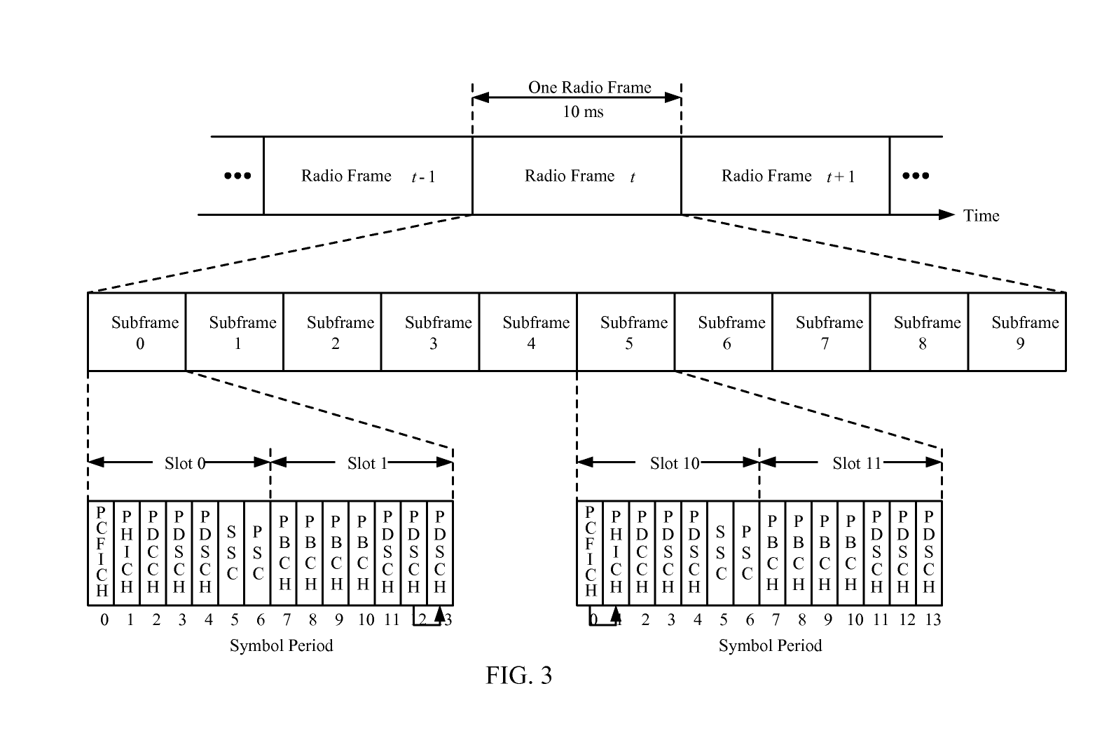

FIG. 3 shows an example downlink frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 14 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of subframes 0 and 5 of each radio frame with the normal cyclic prefix, as shown in FIG. 3. The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in only a portion of the first symbol period of each subframe, although depicted in the entire first symbol period in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNodeB may send a Physical HARQ Indicator Channel (PHICH) and a Physical Downlink Control Channel (PDCCH) in the first M symbol periods of each subframe (M=3 in FIG. 3). The PHICH may carry information to support hybrid automatic retransmission (HARQ). The PDCCH may carry information on uplink and downlink resource allocation for UEs and power control information for uplink channels. Although not shown in the first symbol period in FIG. 3, it is understood that the PDCCH and PHICH are also included in the first symbol period. Similarly, the PHICH and PDCCH are also both in the second and third symbol periods, although not shown that way in FIG. 3. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

In the LTE standard, during generation of an uplink signal, a “guard period” may be created at the beginning of each symbol in order to reduce the impact of inter-symbol interference (ISI). The guard period may be created by adding a Cyclic Prefix (CP) at the beginning of a symbol. The CP may be generated by a transmitter by duplicating some last samples of output and appending them to the beginning of the symbol. As an example, the CP may be approximately 5 μs. At a receiver, the reverse operations may be performed to demodulate the signal. A number of samples corresponding to the length of the CP may be removed prior to processing the received signal.

In some scenarios, there may be a time mismatch between a UE and an eNodeB. For example, the UE may have a timing advance or timing delay compared to the eNodeB. The timing advance may cause performance degradation if critical information such as channel state indicator (CQI) modulation symbols are omitted from a subframe.

Certain aspects of the present disclosure propose methods for protecting CQI information in a subframe such as a localized frequency division multiplexing (LFDM) subframe. For some aspects, a timing adjustment method may be utilized to adjust time of a UE with respect to an eNodeB. The timing adjustment method may introduce a positive time offset to be used for reducing time mismatch between the UE and the eNodeB. In another aspect, a buffer may be used at the eNodeB to store symbols received by the eNodeB before CP removal. The eNodeB may use the stored symbols and an artificial time delay to ensure that the CQI information is protected. For some aspects, the CQI modulation symbols may not be located at the beginning of an LFDM symbol.

In the eight release of the LTE standard (LTE Rel-8), the uplink channels, such as Physical Uplink Shared Channel (PUSCH), Physical Uplink Control Channel (PUCCH), and Sounding Reference Signals (SRS)) may tolerate some timing offset (e.g., timing delay or timing advance). Performance of these uplink channels may degrade gradually as long as the timing offset is less than the size of the CP. The performance may degrade drastically if the timing offset is larger than the size of CP, which may result in omission of critical information such as CQI. For certain aspects, time alignment of uplink transmissions by UEs in a cell may be achieved by applying a timing advance at each UE transmitter or the eNodeB, relative to downlink timing. The timing advance may compensate for differing propagation delays between different UEs in the cell.

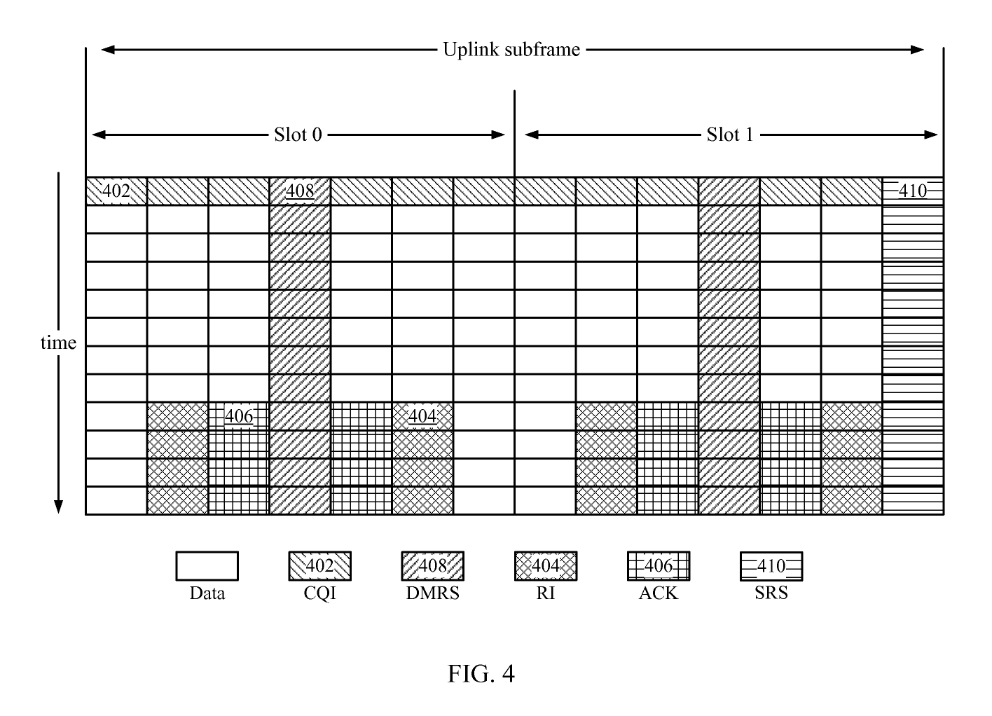

FIG. 4 is a block diagram conceptually illustrating an example of an uplink frame structure in a telecommunications system utilizing LDFM. As illustrated, the channel quality indicator (CQI) 402, rank indicator (RI) 404, acknowledgement (ACK) 406, demodulation reference signal (DMRS) 408 and SRS 410 symbols may be transmitted in the predefined locations in the uplink subframe. For example, in PUSCH transmissions, CQI modulation symbols 404 may be placed at the beginning of each LFDM symbol. Since all the CQI modulation symbols are located at the beginning of a subframe, even a small timing advance at the UE may result in performance degradation. In other words, when CQI is transmitted on PUSCH, CQI performance may be hurt severely when a UE is ahead of the eNodeB system timing.

In some scenarios, if there is a timing advance between UE and eNodeB (e.g., UE is ahead of the eNodeB or has a negative timing offset), CQI modulation symbols may be discarded during the CP removal process at the eNodeB, which may result in sever performance degradation.

In one specific example, in a PUSCH transmission where the PUSCH is assigned 40 Resource Blocks (RB) with a Modulation Coding Scheme (MSC) equal to 20, utilizing 4 bits of wideband CQI with I_offset equal to 15, there may be nine CQI modulation symbols in 16-level Quadrature Amplitude Modulation (QAM). These CQI modulation symbols may all be located at the first chips of nine out of the twelve LDFM data symbols. Assuming that a chip duration may be equal to 0.139 μs, only a 0.139 μμs timing advance may result in discard of all the CQI modulation symbols from the subframe. This may cause CQI erasure and performance degradation, especially in Additive White Gaussian Noise (AWGN) channel where there is no delay.

According to certain aspects, a timing adjustment offset may be employed at a UE to protect CQI. Instead of controlling UE time centered around eNodeB system time, a positive time bias may be used to modify UE timing to ensure that the UE may only retard in a range of system time of the eNodeB and not advance. Most of the uplink channels may be able to tolerate small amounts of positive timing offset, but timing advance may result in performance degradation. For certain aspects, the value of the positive timing bias may be chosen such that the performance degradation for uplink channels is not large. It should be noted that the timing adjustment command may not be effective immediately for the subsequent subframes due to the nature of a timing control loop and implementation delay.

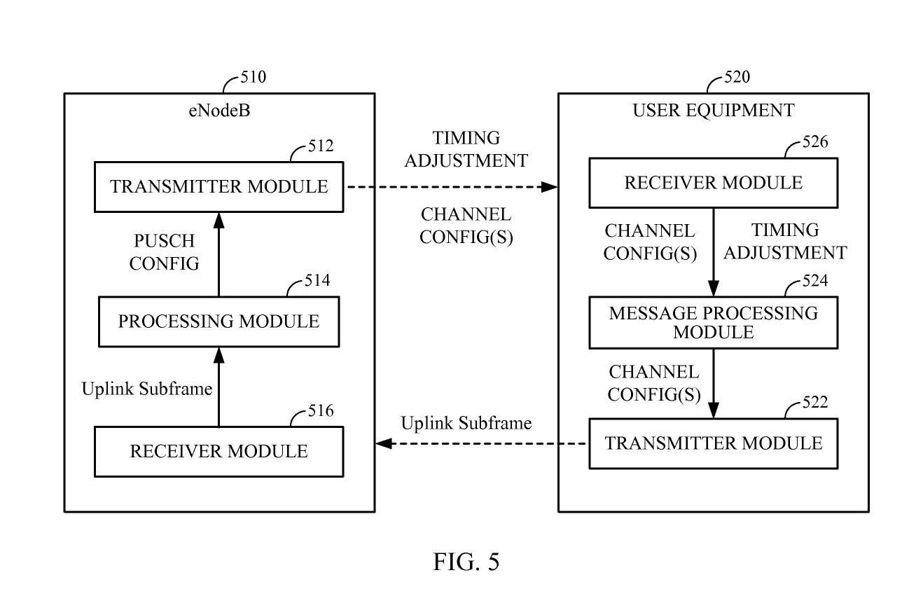

FIG. 5 illustrates a block diagram conceptually illustrating operation of an eNodeB with a user equipment, in accordance with certain aspects of the present disclosure. According to certain aspects, the eNodeB 510 may receive, via a receiver module 516, an uplink subframe from the UE 520. The eNodeB may process the subframe (e.g., detect, decode) using a processing module 514 and generate timing adjustment commands to transmit to the UE to be used for future transmissions.

The processing module 514 may also be configured to determine resources to be used to transmit timing adjustment commands and other channel configuration parameters to the UE. As illustrated, this information may be provided to a transmitter module 512, to be transmitted to the UE 520.

The UE 520 may receive the configuration information and timing adjustment commands, via a receiver module 526, and provide the information to a message processing module 524. The message processing module may utilize the received information, for example, to adjust timing of uplink transmissions and to determine the resources that are used for the transmissions. The UE may also extract PUSCH parameters for transmission of uplink subframes to the eNodeB. The UE 520 may send the subframes (via a transmitter module 522) on the assigned PUSCH utilizing the adjusted timing.

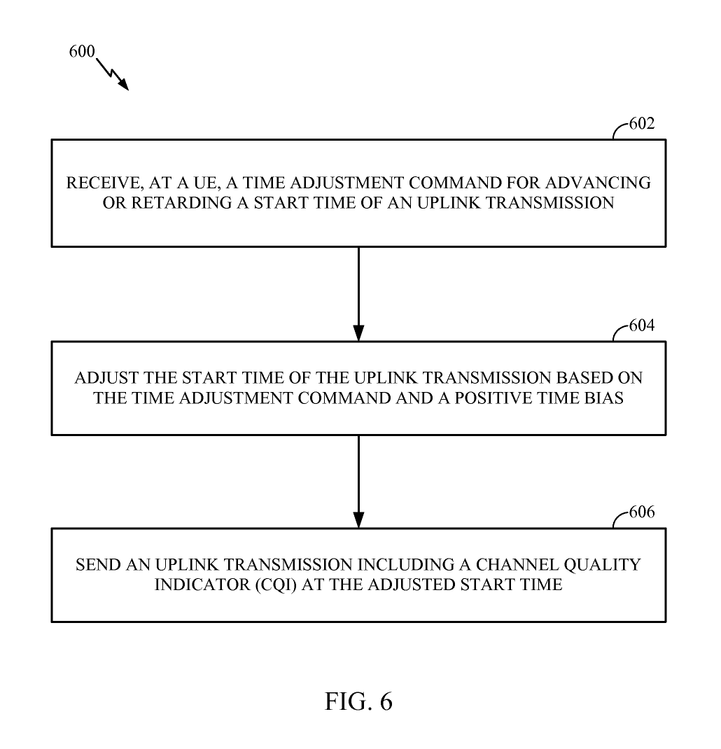

FIG. 6 illustrates exemplary operations 600 that may be performed by a UE in accordance with aspects of the present disclosure. At 602, the UE may receive a time adjustment command for advancing or retarding a start time of an uplink transmission. At 604, a UE may adjust the start time of the uplink transmission based on the time adjustment command and a positive time bias. In one aspect, the positive time bias may be selected by the UE so that adjusted start time of the uplink transmission preserves CQI during the CP removal process. In another aspect, the positive time bias may be received from the eNodeB. At 606, the UE may send an uplink transmission including CQI information at the adjusted start time. In one aspect, the uplink transmission comprises CQI in a PUSCH, in which the CQI is located at the beginning of the transmission.

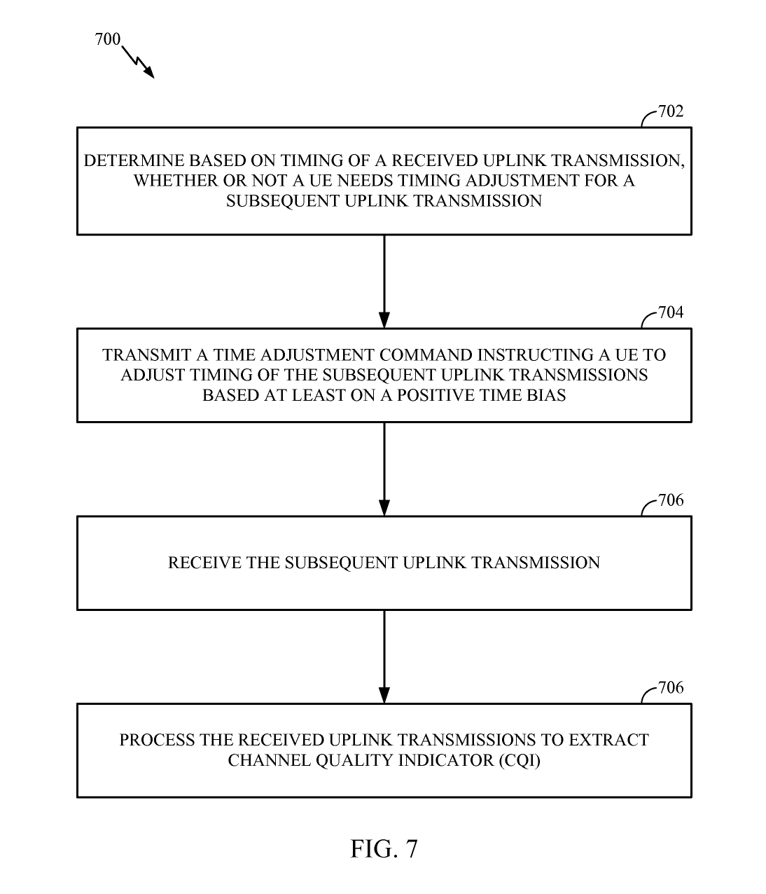

FIG. 7 illustrates exemplary operations 700 that may be performed by an eNodeB in accordance with aspects of the present disclosure. At 702, the eNodeB may determine, based on timing of a received uplink transmission, whether or not a UE has a timing offset and needs timing adjustment for a subsequent uplink transmission. In one aspect, the timing offset may be a timing advance.

At 704, the eNodeB may transmit a time adjustment command instructing a UE to adjust timing of the subsequent uplink transmission based at least on a positive time bias. In one aspect, the positive time bias is selected such that the adjusted start time of the uplink transmissions preserves CQI during a cyclic prefix removal process.

In one aspect, after the eNodeB determines a timing offset, the eNodeB may itself apply the positive time bias to the timing offset. In an alternative aspect, before the eNodeB transmits the time adjustment command, the eNodeB may apply the positive time bias to the command. In one aspect, after the eNodeB detects a timing offset, if the timing offset is a negative timing offset, the eNodeB may transmit a timing adjustment command to request a UE to delay until the UE is aligned with or slightly behind the system timing. If the detected timing offset is a positive timing offset, the eNodeB may perform conventional timing control.

At 706, the eNodeB may receive the subsequent uplink transmission. In one aspect, the uplink transmission may be PUSCH having CQI symbols, wherein the CQI is arranged in the beginning of the transmission. At 708, the eNodeB may process the received uplink transmission to extract CQI. In one aspect, the eNodeB may process PUSCH such that CQI is not removed during CP removal process.

For certain aspects of the present disclosure, a buffer may be employed by an eNodeB for storing CQI on PUSCH. Instead of blindly discarding CP from PUSCH, an eNodeB may use a large buffer to temporarily store symbols that are removed during CP removal process. If a UE is advanced in time, the stored symbols may be used to recover CQI information. In one aspect, an artificial timing delay may be inserted in subframes with CQI on PUSCH before CP removal procedure is performed. Value of the artificial timing delay may be chosen such that if the UE and the eNodeB are aligned, the performance degradation of the system because of the artificial delay is not large (e.g., less than a tolerable threshold).

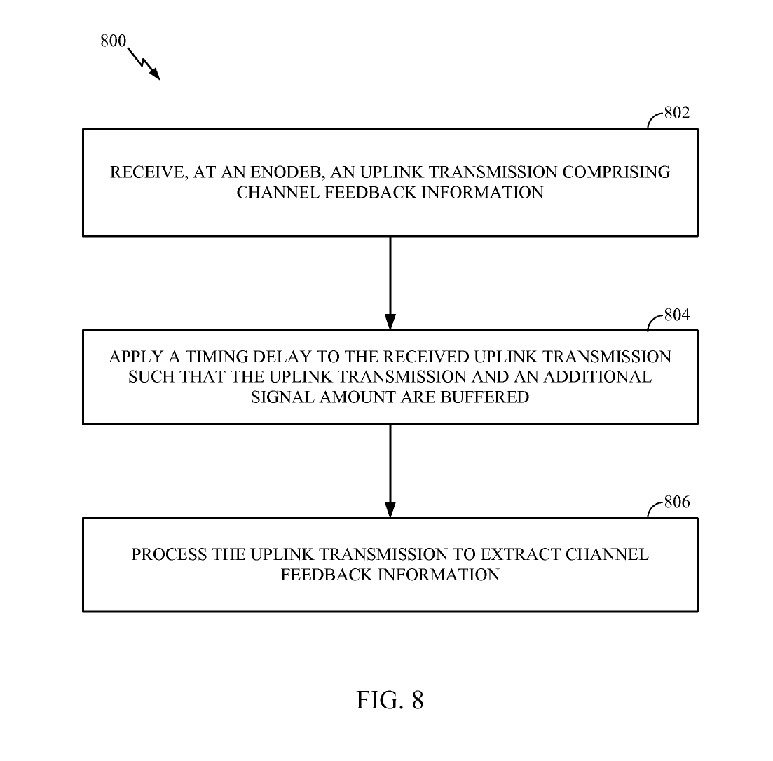

FIG. 8 illustrates exemplary operations 800 that may be performed by an eNodeB to protect CQI information, in accordance with aspects of the present disclosure. At 802, the eNodeB may receive an uplink transmission comprising channel feedback information. In one aspect, the received uplink transmission on PUSCH may be stored in a buffer temporarily.

At 804, the eNodeB may apply a timing delay to the received uplink transmission such that the uplink transmission and an additional signal amount are buffered. For certain aspects, the timing delay may be applied to subframes with CQI on PUSCH. The timing delay may be selected such that the channel feedback information is preserved during a cyclic prefix removal process.

In one aspect, the timing delay may be applied when the most recently detected and/or filtered timing offset is a timing advance or a very small timing delay, or based on some other criteria. At 806, the eNodeB may process the uplink transmission to extract channel feedback information and data.

It should be noted that applying the positive time offset to the signals received from a UE, may result in reduction in performance of other users, if signals from multiple users are received in the same subframe. However, performance degradation of other users may be minimized by utilizing more than one demodulation and decoding processes. According to certain aspects, at least two separate demodulation and decoding processes may be used in the eNodeB. In one aspect, a first set of demodulation and decoding circuitry may be used for processing signals received from users with CQI on PUSCH with an inserted artificial timing delay. A second set of demodulation and decoding circuitry may be used for processing signals received from all other users (e.g., other than the users with CQI on PUSCH).

In another variation of the above scheme, a first set of demodulation and decoding circuitry may be used for processing the signals received from all users, while a second set of demodulation and decoding circuitry with an inserted artificial timing delay may be used for processing signals received from users with CQI on PUSCH. Demodulated and decoded results may be selected from the two sets of circuitry according to a detected timing offset in the current subframe, or based on cyclic redundancy check (CRC) for data, or erasure decoding for CQI, or some other suitable criteria.

In one aspect, a first set of demodulation and decoding circuitry may be used for processing a data part of uplink transmission for all users, while a second set of demodulation and decoding circuitry may be used for processing the CQI part for other users with an inserted artificial timing delay.

For certain aspects of the present disclosure, channel feedback information may be transmitted on symbols other than the first symbol of a subframe in an uplink transmission. In one aspect, CQI modulation symbols may be placed at the end of the LFDM symbols. In another aspect, CQI modulation symbols may be placed at any position other than the beginning of the LFDM symbols. In one aspect, the position of CQI within the frame may be spread over time, as is done with acknowledgement/negative acknowledgment symbols, and with rank indicator symbols.

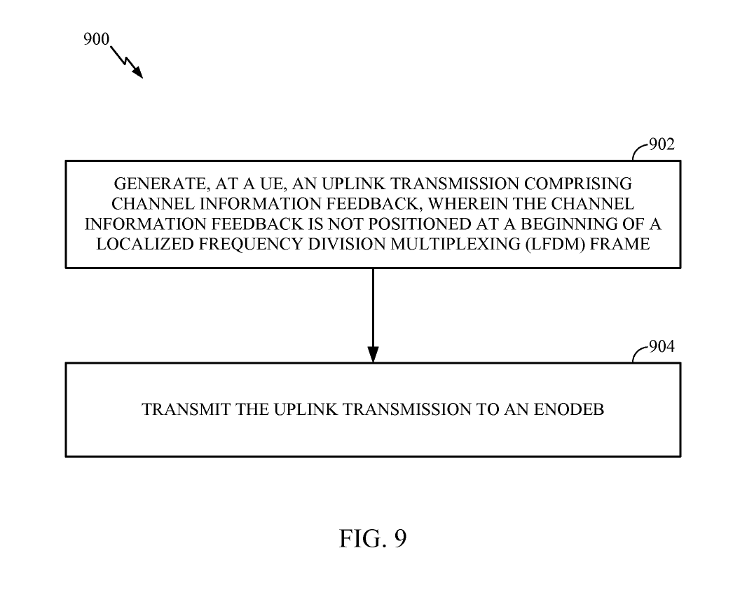

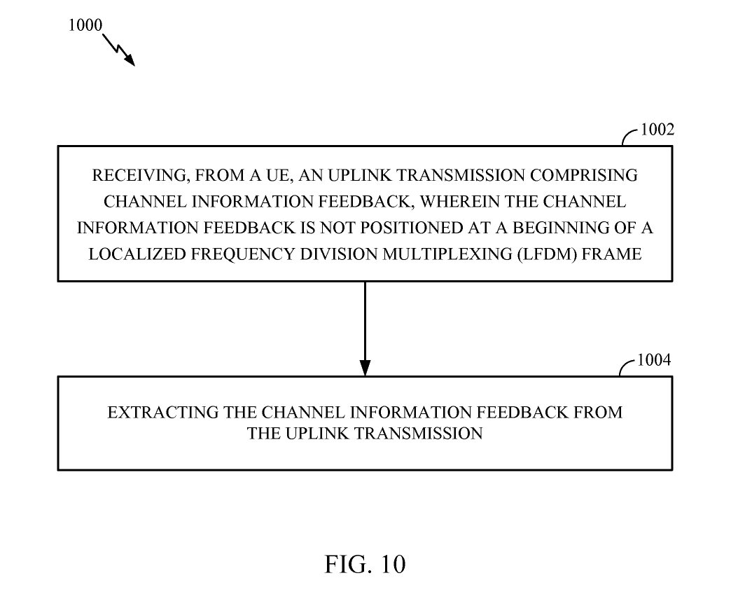

FIGS. 9 and 10 illustrate exemplary operations 900 and 1000 that may be performed by a UE and an eNodeB, respectively, in accordance with certain aspects of the present disclosure.

Referring first to FIG. 9, at 902, a UE may generate an uplink transmission comprising channel information feedback, wherein the channel information feedback is not positioned in the beginning of a LFDM frame in time. At 904, the UE may transmit the uplink transmission to an eNodeB. In one aspect, the uplink transmission may comprise CQI on PUSCH.

Referring next to FIG. 10, at 1002, the eNodeB may receive, from the UE, an uplink transmission that may comprise channel information feedback. The channel information feedback may not be positioned at the beginning of a LDFM symbol. In one aspect, the uplink transmission may comprise CQI on PUSCH. At 1004, the eNodeB may extract the channel information feedback from the received uplink transmission. The eNodeB may then use the CQI information to process the uplink transmission.

While several approaches have been discussed above, it is acknowledged that one or a combination of the above approaches may be used to mitigate the impact of timing mismatch (e.g., timing advance) between a UE and an eNodeB on system performance and to protect CQI information.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for scheduling channel information feedback in a wireless system, comprising:
receiving, at a UE, a time adjustment command for advancing or retarding a start time of an uplink transmission;
adjusting the start time of the uplink transmission based on the time adjustment command and a positive time bias; and
sending an uplink transmission including a channel quality indicator (CQI) at the adjusted start time.

2. The method of claim 1, wherein the positive time bias is selected so that the adjusted start time of the uplink transmissions preserves CQI during a cyclic prefix removal process.

3. The method of claim 1, wherein sending an uplink transmission including CQI comprises sending Physical Uplink Shared Channel (PUSCH), wherein the CQI is arranged in the beginning of the transmission.

4. The method of claim 1, wherein the positive time bias is determined by and received from an eNodeB.

5. The method of claim 1, wherein start time of a plurality of uplink channels are adjusted using the positive time bias.

6. An apparatus for scheduling channel information feedback in a wireless system, comprising:
means for receiving, at a UE, a time adjustment command for advancing or retarding a start time of an uplink transmission;
means for adjusting the start time of the uplink transmission based on the time adjustment command and a positive time bias; and
means for sending an uplink transmission including a channel quality indicator (CQI) at the adjusted start time.

7. The apparatus of claim 6, wherein the positive time bias is selected so that the adjusted start time of the uplink transmissions preserves CQI during a cyclic prefix removal process.

8. The apparatus of claim 6, wherein the means for sending an uplink transmission including CQI comprises means for sending Physical Uplink Shared Channel (PUSCH), wherein the CQI is arranged in the beginning of the transmission.

9. The apparatus of claim 6, wherein the positive time bias is determined by and received from an eNodeB.

10. The apparatus of claim 6, wherein start time of a plurality of uplink channels are adjusted using the positive time bias.

11. An apparatus for scheduling channel information feedback in a wireless system, comprising:
at least one processor configured to:
receive, at a UE, a time adjustment command for advancing or retarding a tart time of an uplink transmission;
adjust the start time of the uplink transmission based on the time adjustment command and a positive time bias; and
send an uplink transmission including a channel quality indicator (CQI) at the adjusted start time; and
a memory coupled to the at least one processor.

12. The apparatus of claim 11, wherein the positive time bias is selected so that the adjusted start time of the uplink transmissions preserves CQI during a cyclic prefix removal process.

13. The apparatus of claim 11, wherein the at least one processor is configured to send an uplink transmission including CQI by sending Physical Uplink Shared Channel (PUSCH), wherein the CQI is arranged in the beginning of the transmission.

14. The apparatus of claim 11, wherein the positive time bias is determined by and received from an eNodeB.

15. The apparatus of claim 11, wherein start time of a plurality of uplink channels are adjusted using the positive time bias.

16. A computer-program product for scheduling channel information feedback in a wireless system, comprising:
a computer-readable medium comprising code for:
receiving, at a UE, a time adjustment command for advancing or retarding a start time of an uplink transmission;
adjusting the start time of the uplink transmission based on the time adjustment command and a positive time bias; and
sending an uplink transmission including a channel quality indicator (CQI) at the adjusted start time.

17. The computer-program product of claim 16, wherein the positive time bias is selected so that the adjusted start time of the uplink transmissions preserves CQI during a cyclic prefix removal process.

18. The computer-program product of claim 16, wherein the code for sending an uplink transmission including CQI comprises code for sending Physical Uplink Shared Channel (PUSCH), wherein the CQI is arranged in the beginning of the transmission.

19. The computer-program product of claim 16, wherein the positive time bias is determined by and received from an eNodeB.

20. The computer-program product of claim 16, wherein start time of a plurality of uplink channels are adjusted using the positive time bias.

21. A method for scheduling channel information feedback in a wireless system, comprising:
determining, based on timing of a received uplink transmission, whether or not a UE needs timing adjustment for a subsequent uplink transmission;
transmitting a time adjustment command instructing a UE to adjust timing of the subsequent uplink transmissions based at least on a positive time bias;
receiving the subsequent uplink transmission; and
processing the received uplink transmissions to extract channel quality indicator (CQI).

22. The method of claim 21, wherein the positive time bias is selected such that the adjusted start time of the uplink transmissions preserves CQI during a cyclic prefix removal process.

23. The method of claim 21, wherein processing the received uplink transmissions comprises not removing the channel information feedback during a cyclic prefix removal process, the channel information feedback including channel quality indicator (CQI).

24. The method of claim 21, wherein determining whether or not the UE needs timing adjustment comprises:
determining a time value for adjusting or retarding the subsequent uplink transmission;
applying a timing bias to the time value to generate an updated time value;
transmitting the updated time value to the UE for timing adjustment.

25. The method of claim 24, further comprising:
modifying the time adjustment command based on the timing bias.

26. An apparatus for scheduling channel information feedback in a wireless system, comprising:
means for determining, based on timing of a received uplink transmission, whether or not a UE needs timing adjustment for a subsequent uplink transmission;
means for transmitting a time adjustment command instructing a UE to adjust timing of the subsequent uplink transmissions based at least on a positive time bias;
means for receiving the subsequent uplink transmission; and
means for processing the received uplink transmissions to extract channel quality indicator (CQI).

27. The apparatus of claim 26, wherein the positive time bias is selected such that the adjusted start time of the uplink transmissions preserves CQI during a cyclic prefix removal process.

28. The apparatus of claim 26, wherein the means for processing the received uplink transmissions comprises means for not removing the channel information feedback during a cyclic prefix removal process, the channel information feedback including channel quality indicator (CQI).

29. The apparatus of claim 26, wherein the means for determining whether or not the UE needs timing adjustment comprises:
means for determining a time value for adjusting or retarding the subsequent uplink transmission;
means for applying a timing bias to the time value to generate an updated time value;
means for transmitting the updated time value to the UE for timing adjustment.

30. The apparatus of claim 29, further comprising:
means for modifying the time adjustment command based on the timing bias.

31. An apparatus for scheduling channel information feedback in a wireless system, comprising:
at least one processor configured to:
determine, based on timing of a received uplink transmission, whether or not a UE needs timing adjustment for a subsequent uplink transmission;
transmit a time adjustment command instructing a UE to adjust timing of the subsequent uplink transmissions based at least on a positive time bias;
receive the subsequent uplink transmission; and
process the received uplink transmissions to extract channel quality indicator (CQI); and
a memory coupled to the at least one processor.

32. The apparatus of claim 31, wherein the positive time bias is selected such that the adjusted start time of the uplink transmissions preserves CQI during a cyclic prefix removal process.

33. The apparatus of claim 31, wherein the at least one processor is configured to process the received uplink transmissions by not removing the channel information feedback during a cyclic prefix removal process, the channel information feedback including channel quality indicator (CQI).

34. The apparatus of claim 31, wherein the at least one processor is configured to determine whether or not the UE needs timing adjustment by:
determining a time value for adjusting or retarding the subsequent uplink transmission;
applying a timing bias to the time value to generate an updated time value;
transmitting the updated time value to the UE for timing adjustment.

35. The apparatus of claim 34, wherein the at least one processor is further configured to:
modify the time adjustment command based on the timing bias.

36. A computer-program product for scheduling channel information feedback in a wireless system, comprising:
a computer-readable medium comprising code for:
determining, based on timing of a received uplink transmission, whether or not a UE needs timing adjustment for a subsequent uplink transmission;
transmitting a time adjustment command instructing a UE to adjust timing of the subsequent uplink transmissions based at least on a positive time bias;
receiving the subsequent uplink transmission; and
processing the received uplink transmissions to extract channel quality indicator (CQI).

37. The computer-program product of claim 36, wherein the positive time bias is selected such that the adjusted start time of the uplink transmissions preserves CQI during a cyclic prefix removal process.

38. The computer-program product of claim 36, wherein the code for processing the received uplink transmissions comprises code for not removing the channel information feedback during a cyclic prefix removal process, the channel information feedback including channel quality indicator (CQI).

39. The computer-program product of claim 36, wherein the code for determining whether or not the UE needs timing adjustment comprises code for:
determining a time value for adjusting or retarding the subsequent uplink transmission;
applying a timing bias to the time value to generate an updated time value;
transmitting the updated time value to the UE for timing adjustment.

40. The computer-program product of claim 39, further comprising code for:
modifying the time adjustment command based on the timing bias.

41. A method for scheduling channel information feedback in a wireless system, comprising:
receiving, at an eNodeB, an uplink transmission comprising channel feedback information;
applying a timing delay to the received uplink transmission such that the uplink transmission and an additional signal amount are buffered; and
processing the uplink transmission to extract channel feedback information.

42. The method of claim 41, further comprising:
storing the received uplink transmission comprising Physical Uplink Shared Channel including channel quality indicator (CQI).

43. The method of claim 41, wherein the timing delay is selected such that the channel feedback information is preserved during a cyclic prefix removal process

44. The method of claim 41, further comprising:
detecting a timing offset from previous uplink transmissions; and
applying the timing delay when the detected timing offset is a timing advance or a small delay.

45. The method of claim 41, wherein processing comprises:
utilizing a first set of demodulation and decoding circuitry for processing undelayed uplink transmissions that do not contain channel feedback information transmitted on a shared uplink channel; and
utilizing a second set of demodulation and decoding circuitry for processing delayed uplink transmissions that contain channel feedback information transmitted on a shared uplink channel.

46. The method of claim 45, further comprising:
selecting processed uplink transmissions based on a detected timing offset;
wherein the first and second set of demodulation and decoding circuitry are further configured to process both undelayed uplink transmissions and delayed uplink transmissions.

47. The method of claim 42, further comprising:
utilizing a first set of demodulation and decoding circuitry for processing a data portion of uplink transmissions; and
utilizing a second set of demodulation and decoding circuitry for processing a portion of delayed uplink transmissions containing channel feedback information transmitted on a shared uplink channel.

48. An apparatus for scheduling channel information feedback in a wireless system, comprising:
means for receiving, at an eNodeB, an uplink transmission comprising channel feedback information;
means for applying a timing delay to the received uplink transmission such that the uplink transmission and an additional signal amount are buffered; and
means for processing the uplink transmission to extract channel feedback information.

49. The apparatus of claim 48, further comprising:
means for storing the received uplink transmission comprising Physical Uplink Shared Channel including channel quality indicator (CQI).

50. The apparatus of claim 48, wherein the timing delay is selected such that the channel feedback information is preserved during a cyclic prefix removal process

51. The apparatus of claim 48, further comprising:
means for detecting a timing offset from previous uplink transmissions; and
means for applying the timing delay when the detected timing offset is a timing advance or a small delay.

52. The apparatus of claim 48, wherein the means for processing comprises:
means for utilizing a first set of demodulation and decoding circuitry for processing undelayed uplink transmissions that do not contain channel feedback information transmitted on a shared uplink channel; and
means for utilizing a second set of demodulation and decoding circuitry for processing delayed uplink transmissions that contain channel feedback information transmitted on a shared uplink channel.

53. The apparatus of claim 52, further comprising:
means for selecting processed uplink transmissions based on a detected timing offset;
wherein the first and second set of demodulation and decoding circuitry are further configured to process both undelayed uplink transmissions and delayed uplink transmissions.

54. The apparatus of claim 49, further comprising:
means for utilizing a first set of demodulation and decoding circuitry for processing a data portion of uplink transmissions; and
means for utilizing a second set of demodulation and decoding circuitry for processing a portion of delayed uplink transmissions containing channel feedback information transmitted on a shared uplink channel.

55. An apparatus for scheduling channel information feedback in a wireless system, comprising:
at least one processor configured to:
receive, at an eNodeB, an uplink transmission comprising channel feedback information;
apply a timing delay to the received uplink transmission such that the uplink transmission and an additional signal amount are buffered; and
process the uplink transmission to extract channel feedback information;
and
a memory coupled to the at least one processor.

56. The apparatus of claim 55, wherein the at least one processor is further configured to:
store the received uplink transmission comprising Physical Uplink Shared Channel including channel quality indicator (CQI).

57. The apparatus of claim 55, wherein the timing delay is selected such that the channel feedback information is preserved during a cyclic prefix removal process

58. The apparatus of claim 55, wherein the at least one processor is further configured to:
detect a timing offset from previous uplink transmissions; and
apply the timing delay when the detected timing offset is a timing advance or a small delay.

59. The apparatus of claim 55, wherein the at least one processor is configured to process by:
utilizing a first set of demodulation and decoding circuitry for processing undelayed uplink transmissions that do not contain channel feedback information transmitted on a shared uplink channel; and
utilizing a second set of demodulation and decoding circuitry for processing delayed uplink transmissions that contain channel feedback information transmitted on a shared uplink channel.

60. The apparatus of claim 59, wherein the at least one processor is further configured to:
select processed uplink transmissions based on a detected timing offset;
wherein the first and second set of demodulation and decoding circuitry are further configured to process both undelayed uplink transmissions and delayed uplink transmissions.

61. The apparatus of claim 56, wherein the at least one processor is further configured to:
utilize a first set of demodulation and decoding circuitry for processing a data portion of uplink transmissions; and
utilize a second set of demodulation and decoding circuitry for processing a portion of delayed uplink transmissions containing channel feedback information transmitted on a shared uplink channel.

62. A computer-program product for scheduling channel information feedback in a wireless system, comprising:
a computer-readable medium comprising code for:
receiving, at an eNodeB, an uplink transmission comprising channel feedback information;
applying a timing delay to the received uplink transmission such that the uplink transmission and an additional signal amount are buffered; and
processing the uplink transmission to extract channel feedback information.

63. The computer-program product of claim 62, further comprising code for:
storing the received uplink transmission comprising Physical Uplink Shared Channel including channel quality indicator (CQI).

64. The computer-program product of claim 62, wherein the timing delay is selected such that the channel feedback information is preserved during a cyclic prefix removal process

65. The computer-program product of claim 62, further comprising code for:
detecting a timing offset from previous uplink transmissions; and
applying the timing delay when the detected timing offset is a timing advance or a small delay.

66. The computer-program product of claim 62, wherein the code for processing comprises code for:
utilizing a first set of demodulation and decoding circuitry for processing undelayed uplink transmissions that do not contain channel feedback information transmitted on a shared uplink channel; and
utilizing a second set of demodulation and decoding circuitry for processing delayed uplink transmissions that contain channel feedback information transmitted on a shared uplink channel.

67. The computer-program product of claim 66, further comprising code for:
selecting processed uplink transmissions based on a detected timing offset;
wherein the first and second set of demodulation and decoding circuitry are further configured to process both undelayed uplink transmissions and delayed uplink transmissions.

68. The computer-program product of claim 63, further comprising code for:
utilizing a first set of demodulation and decoding circuitry for processing a data portion of uplink transmissions; and
utilizing a second set of demodulation and decoding circuitry for processing a portion of delayed uplink transmissions containing channel feedback information transmitted on a shared uplink channel.

69. A method for transmitting channel information feedback in a wireless system, comprising:
generating, at a UE, an uplink transmission comprising channel information feedback, wherein the channel information feedback is not positioned at a beginning of a localized frequency division multiplexing (LFDM) frame; and
transmitting the uplink transmission to an eNodeB.

70. An apparatus for transmitting channel information feedback in a wireless system, comprising:
means for generating, at a UE, an uplink transmission comprising channel information feedback, wherein the channel information feedback is not positioned at a beginning of a localized frequency division multiplexing (LFDM) frame; and
means for transmitting the uplink transmission to an eNodeB.

71. An apparatus for transmitting channel information feedback in a wireless system, comprising:
at least one processor configured to:
generate, at a UE, an uplink transmission comprising channel information feedback, wherein the channel information feedback is not positioned at a beginning of a localized frequency division multiplexing (LFDM) frame; and
transmit the uplink transmission to an eNodeB; and
a memory coupled to the at least one processor.

72. A computer-program product for transmitting channel information feedback in a wireless system, comprising:
a computer-readable medium comprising code for:
generating, at a UE, an uplink transmission comprising channel information feedback, wherein the channel information feedback is not positioned at a beginning of a localized frequency division multiplexing (LFDM) frame; and
transmitting the uplink transmission to an eNodeB.

73. A method for processing channel information feedback in a wireless system, comprising:
receiving, from a UE, an uplink transmission comprising channel information feedback, wherein the channel information feedback is not positioned at a beginning of a localized frequency division multiplexing (LFDM) frame; and
extracting the channel information feedback from the uplink transmission.

74. An apparatus for processing channel information feedback in a wireless system, comprising:
means for receiving, from a UE, an uplink transmission comprising channel information feedback, wherein the channel information feedback is not positioned at a beginning of a localized frequency division multiplexing (LFDM) frame; and
means for extracting the channel information feedback from the uplink transmission.

75. An apparatus for processing channel information feedback in a wireless system, comprising:
at least one processor configured to:
receive, from a UE, an uplink transmission comprising channel information feedback, wherein the channel information feedback is not positioned at a beginning of a localized frequency division multiplexing (LFDM) frame; and
extract the channel information feedback from the uplink transmission;
and
a memory coupled to the at least one processor.

76. A computer-program product for processing channel information feedback in a wireless system, comprising:
a computer-readable medium comprising code for:
receiving, from a UE, an uplink transmission comprising channel information feedback, wherein the channel information feedback is not positioned at a beginning of a localized frequency division multiplexing (LFDM) frame; and
extracting the channel information feedback from the uplink transmission
